(19) United States
(12) Patent Application Publication
(10) Pub. No.: US 2005/0165601 A1
(43) Pub. Date: Jul. 28, 2005

(54) Method and apparatus for determining when a user has ceased inputting data

(76) Inventors: Anurag K. Gupta, Calcutta (IN); Tasos Anastasakos, San Jose, CA (US); Hang Shun Raymond Lee, Maroubra (AU)

Correspondence Address: MOTOROLA, INC., 1303 EAST ALGONQUIN ROAD, IL01/3RD, SCHAUMBURG, IL, 60196, US

(21) Appl. No.: 10/767,422

(22) Filed: Jan. 28, 2004

(51) Int. Cl. G06F 17/27; G10L 15/00

(52) U.S. Cl. 704/9; 704/251

(57) ABSTRACT

In a system (200) where a user's input is received by a user interface (201), users are free to use available input modalities in any order and at any time. In order to ensure that all inputs are collected before inferring the user's intent, an multi-modal input fusion (MMIF) module (204) receives the user input and attempts to fill available MMI templates (contained within a database (206)) with the user's input. The MMIF module (204) will wait for further modality inputs if no MMI template is filled. However, if any MMI template within the database (206) is filled completely, the MMIF module (204) will generate a semantic representation of the user's input with the current collection of user inputs. Additionally, if after a predetermined time no MMIF template has been filled, the MMIF module (204) will generate a semantic representation of the current user's input and output this representation.

### FIELD OF THE INVENTION

The present invention relates generally to the determination of when a user's input has ceased and in particular, to a method and apparatus for determining an end of a user input in a human-computer dialogue.

### BACKGROUND OF THE INVENTION

Multimodal input fusion (MMIF) technology is generally used by a system to collect and fuse multiple inputs into a single meaningful representation of the user's intent for further processing. Such a system 100 using MMIF technology is shown in FIG. 1. As shown, system 100 comprises user interface 101 and MMIF module 104. User interface 101 comprises a plurality of modality recognizers 102-103 that receive and decipher a user's input. Typical modality recognizers 102-103 include speech recognizers, type-written recognizers, and hand-writing recognizers. Each modality recognizer 102-103 is specifically designed to decipher an input from a particular input mode. For example, in a multi-modal input comprising both speech and keyboard entries, modality recognizer 102 may serve to decipher the keyboard entry, while modality recognizer 103 may serve to decipher the voice input.

Regardless of the number and modes of input, MMIF module 104 receives deciphered inputs from user interface 101 and integrates (fuses) the inputs into a semantic meaning representation of the user input. The input fusion process in general consists of three steps: (1) collecting inputs from the modality recognizers, (2) deciding the end of a user's input, and (2) integration (fusion) of the collected modality inputs.

In MMIF systems, it is critical to know when a user has finished inputting commands into user interface 101. In particular, the issue of deciding whether the MMIF module should wait for further input or to predicate that the user has completed the current turn is critical in determining a proper input representation of a user's intended instructions. Thus, system 100 needs to ensure that all inputs are collected before inferring the user's intent, and at the same time not waste time waiting if the user has completed their input. Therefore, a need exists for a method and apparatus for determining an end of a user input in a human-computer dialogue system.

### BRIEF DESCRIPTION OF THE DRAWINGS

FIG. 1 is a block diagram of a prior-art system using MMIF technology.

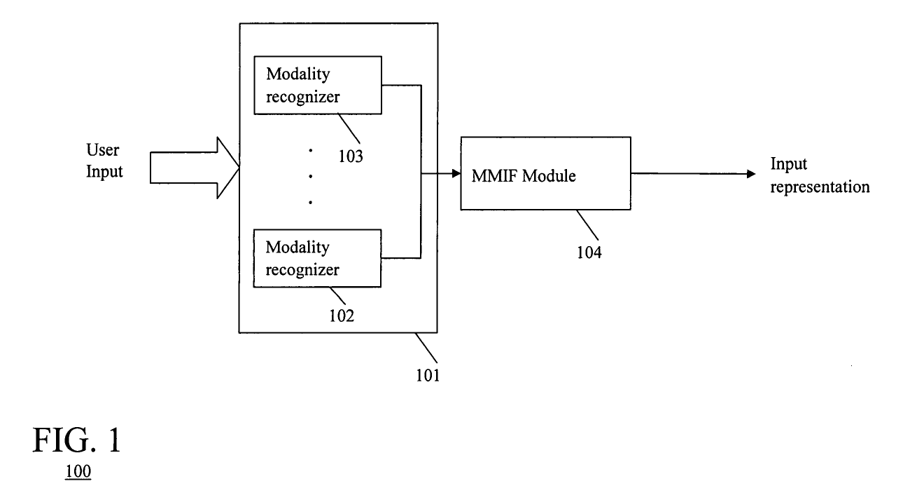

FIG. 2 is a block diagram of a system using MMIF technology.

FIG. 3 illustrates templates for use by the MMIF module of FIG. 2.

FIG. 4 is a block diagram of a system using MMIF technology in accordance with an alternate embodiment of the present invention.

FIG. 5 illustrates the creation of an MMI template.

FIG. 6 is a state diagram showing operation of the system of FIG. 2.

FIG. 7 is a flow chart showing operation of the system of FIG. 2.

### DETAILED DESCRIPTION OF THE DRAWINGS

To address the above-mentioned need, a method and apparatus for determining an end to a user's input is provided herein. In order to ensure that all inputs are collected before inferring the user's intent, an multi-modal input fusion (MMIF) module receives the user input and attempts to fill available MMI templates (contained within a database (206)) with the user's input. The MMIF module will wait for further modality inputs if no MMI template is filled. However, if any MMI template within the database is filled completely, the MMIF module will generate a semantic representation of the user's input with the current collection of user inputs. Additionally, if after a predetermined time no MMIF template has been filled, the MMIF module will generate a semantic representation of the current user's input and output this representation.

The present invention encompasses a method for determining when a user has ceased inputting data. The method comprises the steps of receiving an input from a user, accessing a plurality of templates from a database, and determining if all inputs received from the user fill any templates from the database. A determination is made whether the user has ceased inputting data when the user's inputs fill any template from the database.

The present invention additionally encompasses a method comprising the steps of receiving a plurality of user inputs, determining a content of the input for each of the user inputs, and determining a mode of input for each of the user inputs. A plurality of templates are accessed and a determination is made whether the content and mode of the user inputs fill a template from the plurality of templates. Finally it is determined that the user has ceased inputting data if the user's inputs fill any template.

The present invention additionally encompasses an apparatus comprising a user interface having a plurality of multi-modal user inputs, a template database outputting templates, and a multi-modal input fusion (MMIF) module receiving the multi-modal user inputs and the templates, and determining if a content and mode of inputs fills a template received from the database.

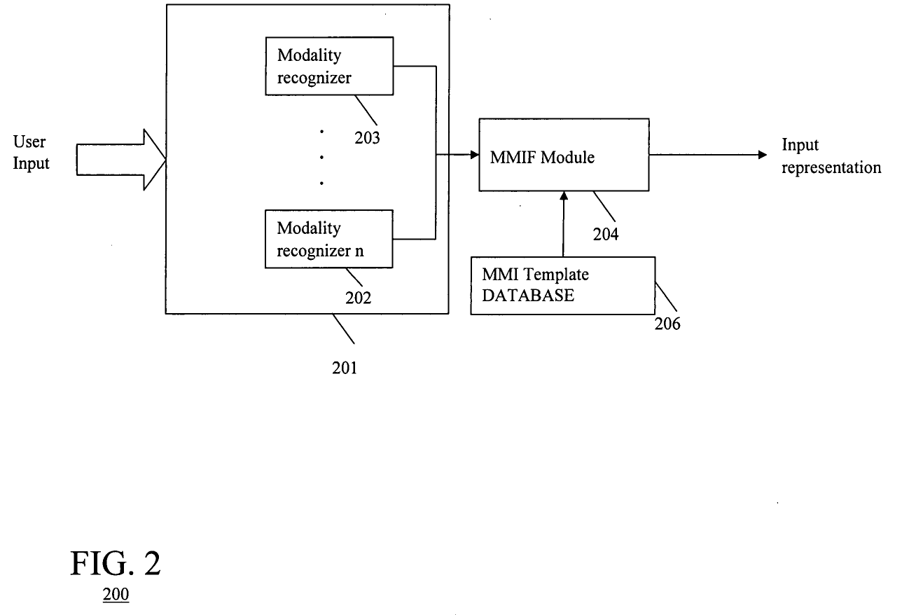

Turning now to the drawings, wherein like numerals designate like components, FIG. 2 is a block diagram of system 200 that outputs a semantic representation of a user's input. As shown, system 200 comprises user interface 201, MMIF module 204, and database 206. It is contemplated that all elements within system 200 are configured in well-known manners with processors, memories, instruction sets, and the like, which function in any suitable manner to perform the function set forth herein.

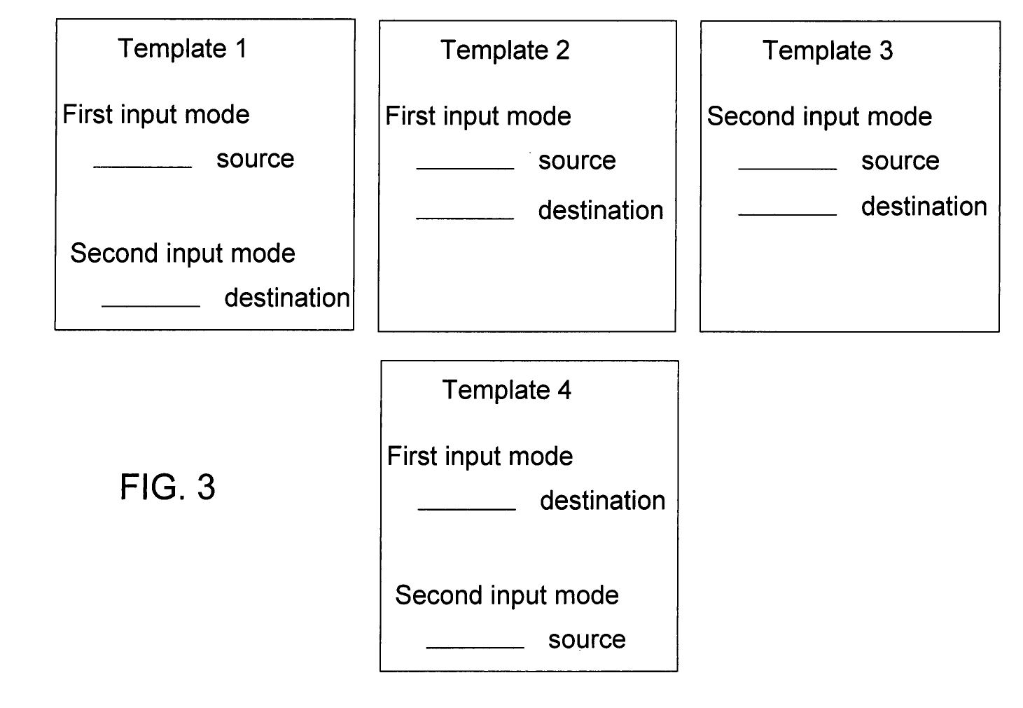

Database 206 is populated with a plurality of templates comprising combinations of possible user inputs and their possible mode of input. In particular, database 206 comprises templates specifying the information to be received from the user, as well as the modality(ies) that a user can use to provide such information. For example, a first template might comprise a first expected input from a first input mode, and a second expected input from a second input mode, while a second template might comprise the first and the second expected inputs from the same input mode. To further elaborate, if MMIF module 204 is expecting a source address and a destination address as inputs, and there exists two input modes, a first template might comprise the source input via the first mode, and the destination input via the second mode, while a second template might comprise both the source and the destination input via the first mode. Similarly, a third template might comprise both the source and the destination input via the second mode, and a fourth template might comprise the source input via the second mode and the destination input via the first mode. Therefore, a template can be considered to comprise a plurality of slots, where each input fills a slot. When all slots are full, it is assumed that a user has completed an input turn. This is illustrated in FIG. 3.

During operation, a user's input is received by user interface 201. As is evident, system 200 comprises multiple input modalities where the user can use a single, all, or any combination of the available modalities (e.g., text, speech, handwriting, . . . etc.). Users are free to use the available modalities in any order and at any time. As discussed above, system 200 needs to ensure that all inputs are collected before inferring the user's intent while at the same time not waste time waiting if the user has completed their input. In order to accomplish this task, MMIF module 204 receives the user input along with a plurality of templates from database 206, and attempts to fill the templates with the user's input and mode of input. MMIF module 204 will determine if all received inputs fill any template, and wait for further modality inputs if no MMI template is filled. However, if any MMI template within database 206 is filled completely, MMIF module 204 generates a semantic representation of the user's input with the current collection of user inputs. Thus, MMIF module 204 outputs a semantic representation of the user's input once a template has been filled.

It should be noted that when no template has been filled, MMIF module 204 will determine if a predetermined amount of time has passed since the last user input, and if so, MMIF module 204 will assume the user's input has ceased, and will generate a semantic representation of the current user's input and output this representation.

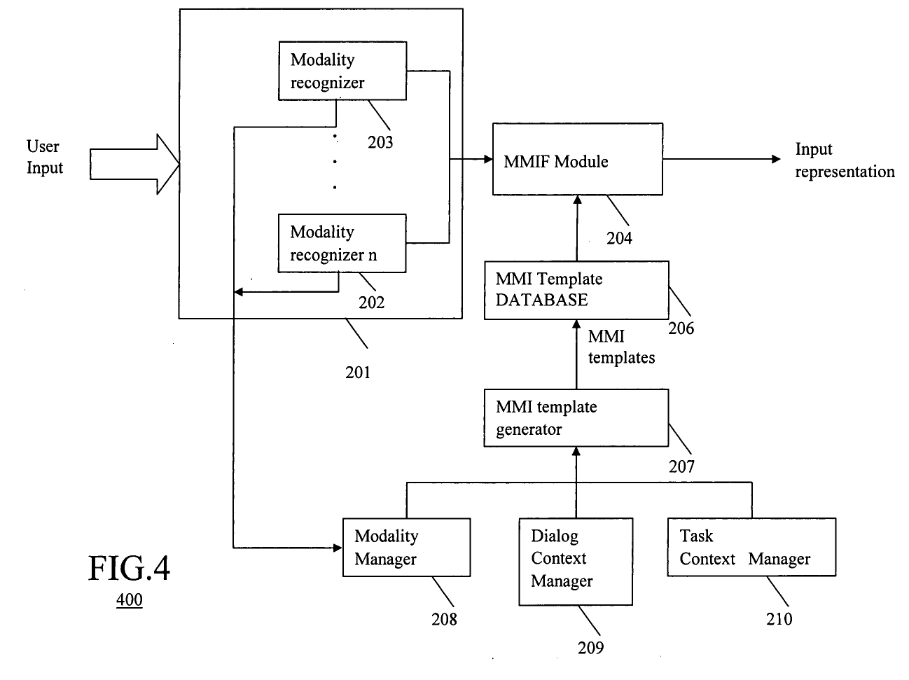

In the preferred embodiment of the present invention templates are static, and generated/stored prior to any input being received by the user. However, in an alternate embodiment of the present invention the templates are dynamic, being constantly updated as the user's environment changes. Such a system is shown in FIG. 4. In particular, FIG. 4 is a block diagram of system 400 that outputs a semantic representation of a user's input. As shown, system 400 is similar to system 200 except for the addition of MMI template generator 207, modality manager 208, dialog context manager 209, and task context 210.

Modality manager 208 is responsible for monitoring modality recognizers 202-203 in user interface 201. In particular, modality manager 208 detects the availability of input modalities and obtains information on each available modality's capability to recognize particular parameters. For example, a connected digit speech recognizer may become available (or unavailable) during the user-computer dialog. As such the modality manager updates its internal state to reflect the current input capability (or incapability) to accept connected digit inputs from the user.

Dialog context manager 209 maintains a record of the history of the dialog between the user and system 200. Dialog context manager 209 provides (as input to MMI template generator 207) a list of discourse obligations that constrain what the user can input in the next dialog turn. For example, the question “What time is it?” is usually replied with the current time as it imposes on the responder an “obligation” to do so. Discourse obligation is a known linguistic phenomenon and has been used in state-of-the-art dialog systems.

Task context manager 210 is responsible for maintaining a task context during the dialog. A task context refers to the history and the current status of the task(s) that the user is working on using the system. As a user typically interacts with a computer with a purpose, i.e. to complete specific task(s), the task context provides information to MMI template generator 207 to predict a next user input. At each dialog turn, task context manager 210 provides to the MMI template generator, a list of task actions and their respective parameters according to the current task context.

MMI template generator 207 receives information related to the availability of modality recognizers (from modality manager), current dialog obligations (from the dialog context manager) and task status (from the task context manager). The information received a set of MMI templates is created, which is then stored in database 206. Because, user inputs are evaluated by MMIF 204 at the semantic level, templates are semantic templates. In particular, a multi-modal input template specifies the information to be received from the user, as well as the modality(ies) that a user can use to provide such information. These templates are utilized by MMIF to determine an end to a user's input.

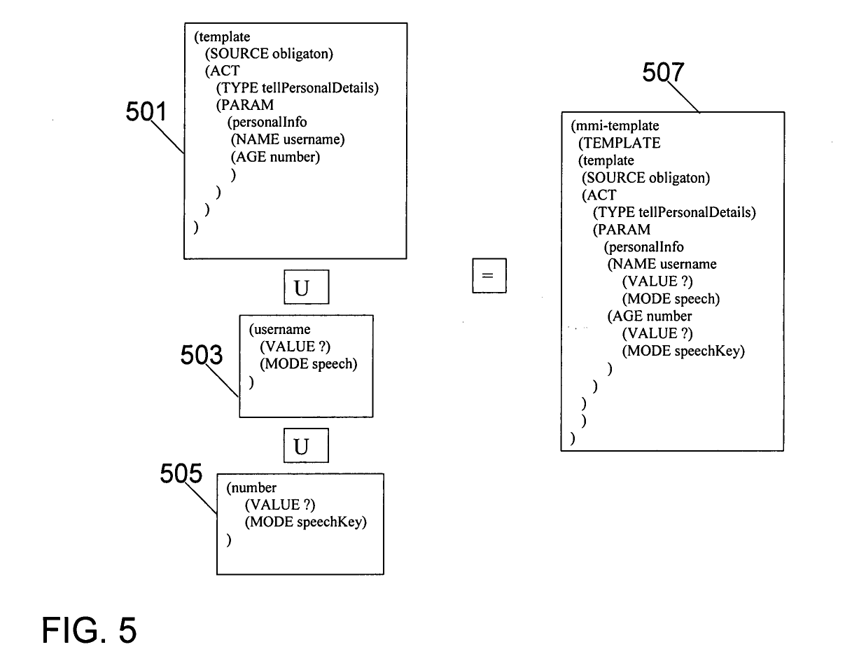

It should be noted that the information received by MMI template generator 207 from managers 208-210 is defined as typed feature structures (TFSs). As a result, the MMI template are a unification of a modality TFS and a dialog obligation or a task TFS. FIG. 5 illustrates the unification process. Dialog obligation template 501 from dialog context manager 209 is unified with modality TFSs 503, 505 from modality manager 208. In particular, dialog obligation template 501 specifies that a user is “obliged” to perform an tellPersonalDetails act by providing his name and age, of type username and number respectively. Modality TFSs 503 and 505 specify that data of type username and number can be provided by speech and by speech and keyboard respectively. MMI template 507, where “VALUE ?” is an expected input from a user, is the result of unification of the TFSs 501-505.

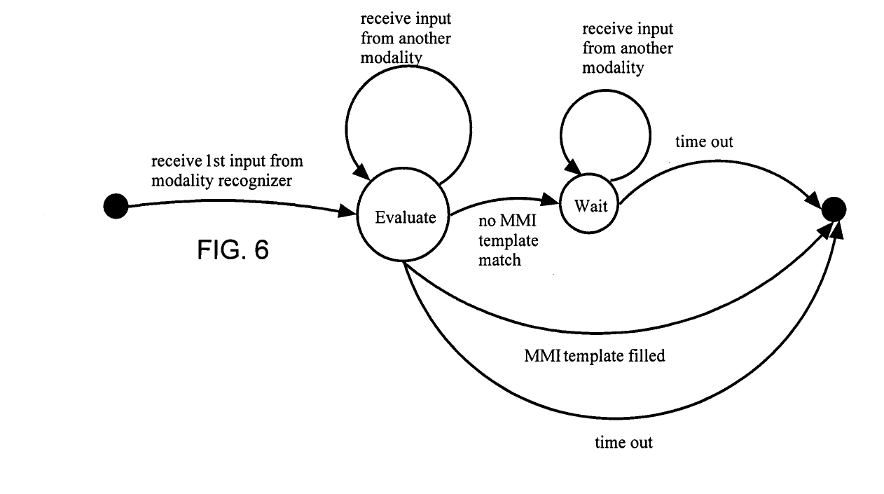

FIG. 6 is a state diagram showing operation of the system of FIG. 2 and FIG. 4. As is evident, MMIF module 204 is idle until it receives its first input for the current dialog turn. Module 204 moves to the evaluate state and matches the new input against MMI templates within database 206. Module 204 will remain in the evaluate state (waiting for further modality inputs) if all MMI templates are unfilled, or partially filled. If an MMI template is filled completely, the MMIF module terminates with the current collection of inputs. If no MMI template can be used to match the current modality input, the MMIF module falls back to the standard “wait” state. This series of events is illustrated in the flow chart of FIG. 5.

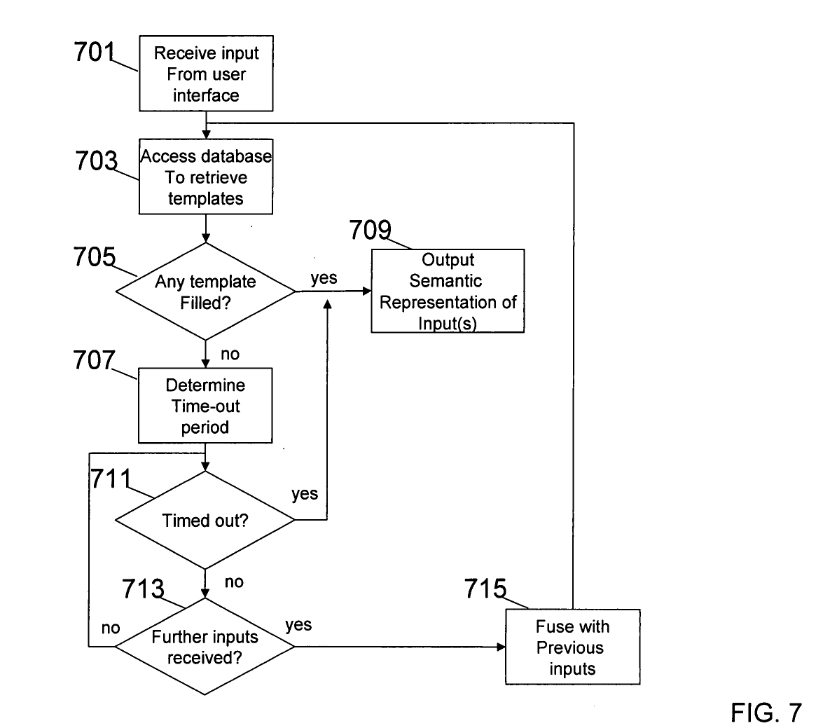

FIG. 7 is a flow chart showing operation of the system of FIG. 2 and FIG. 4. The logic flow begins at step 701 where MMIF module 204 receives a user's input from user interface 201 and determines the content and mode of the user's input. At step 703 MMIF module 204 accesses MMI template database 206 to retrieve a plurality of templates. As discussed above, database 206 may comprise static templates, or alternatively may comprise templates that are dynamically updated by template generator 207 based on available modes of input, an expected response from the user, a list of discourse obligations that constrain what the user can input in the next dialog turn, or the history and the current status of the task(s) that the user is working on.

Dynamically updating templates may be useful in changing environments. For example, consider a situation in which during run-time a speech input mode becomes unavailable due to various reasons (e.g., the user is in a very noisy environment). In this cases, modality manager 208 will disable the speech input, causing all MMI templates (e.g., template 507) to remove the name attribute for the current turn since the user cannot use speech for that turn. In another scenario, assume that handwriting recognition is available and the user can use it to input both username and age attribute of a tellPersonaldetails template. Assume that the user becomes a passenger in bumpy car ride and the user cannot use the handwriting input mode. In such a situation the modality manager 208 may recognize the situation and update all templates to remove this mode of input.

Continuing with the description of FIG. 7, at step 705 MMIF module 204 determines if any template is filled by determining if the content and mode of the user's inputs fill a template from the plurality of templates. If, at step 705, any template is filled, the logic flow continues to step 709 where a semantic output of the user's input is generated. If, however, it was determined at step 705 that no template was filled, the logic flow continues to step 707 where a time-out period is determined. Determining such time-out periods is well known in the art, and may, for example be accomplished as described in U.S. patent application Ser. No. 10/292,094, incorporated by reference herein.

Continuing, once a time-out period has been determined, the logic flow continues to step 711 where it is determined if a time-out has occurred by determining if a predetermined amount of time has passed since the last user input. If a time out has occurred, the logic flow returns to step 709 where a semantic output of the user's input is generated. If, however, it is determined that a time-out has not occurred, the logic flow continues to step 713 where it is determined if further inputs were received by MMIF 204. If, at step 713, further inputs were not received, the logic flow simply returns to step 711. If, however, it is determined that further inputs were received, the further inputs are fused with the previous inputs (step 715) and the logic flow returns to step 701.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for determining when a user has ceased inputting data, the method comprising the steps of:
receiving an input from a user;
accessing a plurality of templates from a database;
determining if all inputs received from the user fill any templates from the database; and
determining that the user has ceased inputting data if the user's inputs fill any template from the database.

2. The method of claim 1 further comprising the steps of:
determining if predetermined amount of time has passed; and
determining that the user has ceased inputting data if the predetermined amount of time has passed.

3. The method of claim 1 wherein the step of receiving the input from the user comprises the step of receiving a multi-modal input from the user.

4. The method of claim 3 wherein the step of receiving the multi-modal input from the user comprises the step of receiving a multimodal input from the group consisting of a text input, a speech input, and a handwritten input.

5. The method of claim 1 wherein the step of accessing the plurality of templates comprises the step of accessing a plurality of semantic templates.

6. The method of claim 1 wherein the step of accessing the plurality of templates comprises the step of accessing a plurality of templates comprising combinations of possible user inputs and their possible mode of input.

7. The method of claim 1 further comprising the step of dynamically updating templates from the database.

8. The method of claim 7 wherein the step of dynamically updating templates from the database comprises the step of dynamically updating templates based on a characteristic taken from the group consisting of available modes of input, an expected response from the user, a list of discourse obligations that constrain what the user can input in the next dialog turn, and the history and the current status of the task(s) that the user is working on.

9. A method comprising the steps of:
receiving a plurality of user inputs;
determining a content of the input for each of the user inputs;
determining a mode of input for each of the user inputs;
accessing a plurality of templates;
determining if the content and mode of the user inputs fill a template from the plurality of templates; and
determining that the user has ceased inputting data if the user's inputs fill any template.

10. The method of claim 9 further comprising the steps of:
determining if predetermined amount of time has passed; and
determining that the user has ceased inputting data if the predetermined amount of time has passed.

11. The method of claim 9 wherein the step of receiving the plurality of user inputs comprises the step of receiving a plurality of multi-modal inputs from the user.

12. The method of claim 11 wherein the step of receiving the plurality of user inputs comprises the step of receiving a plurality of multimodal inputs from the group consisting of a text input, a speech input, and a handwritten input.

13. The method of claim 9 wherein the step of accessing the plurality of templates comprises the step of accessing a plurality of semantic templates.

14. The method of claim 9 wherein the step of accessing the plurality of templates comprises the step of accessing a plurality of templates comprising combinations of possible user inputs and their possible mode of input.

15. The method of claim 9 further comprising the step of dynamically updating the plurality of templates.

16. The method of claim 15 wherein the step of dynamically updating the plurality of templates comprises the step of dynamically updating templates based on a characteristic taken from the group consisting of available modes of input, an expected response from the user, a list of discourse obligations that constrain what the user can input in the next dialog turn, and the history and the current status of the task(s) that the user is working on.

17. An apparatus comprising:
a user interface having a plurality of multi-modal user inputs;
a template database outputting templates; and
a multi-modal input fusion (MMIF) module receiving the multi-modal user inputs and the templates, and determining if a content and mode of inputs fills a template received from the database.

18. The apparatus of claim 17 wherein:
the MMIF module determines that a user has ceased inputting data when the content and mode of inputs fill a template received from the database, or a predetermined amount of time has passed since receiving a last input from the user.

19. The apparatus of claim 17 wherein the templates comprise semantic templates.

20. The apparatus of claim 17 further comprising a template generator dynamically updating the templates.
